(19) United States
(12) Patent Application Publication
(10) Pub. No.: US 2017/0257525 A1
(43) Pub. Date: Sep. 7, 2017

(54) IMAGE PROCESSING APPARATUS, IMAGE PROCESSING METHOD, AND COMPUTER PROGRAM PRODUCT

(71) Applicant: Yuichi NODA, Kanagawa (JP)

(72) Inventor: Yuichi NODA, Kanagawa (JP)

(21) Appl. No.: 15/434,653

(22) Filed: Feb. 16, 2017

(30) Foreign Application Priority Data
Mar. 1, 2016 (JP) 2016-039162

(51) Int. Cl. H04N 1/44; H04N 1/32

(52) U.S. Cl. CPC H04N 1/444; H04N 1/32352; H04N 1/4413; H04N 1/32122; H04N 2201/0094; H04N 2201/3205; H04N 2201/3233

(57) ABSTRACT

An image processing apparatus includes a reading control unit, an extractor, an acquirer, an operation acceptance unit, and a storage control unit. The reading control unit reads a printed material containing a digital watermark to obtain image data of the printed material. The extractor extracts, from the digital watermark contained in the image data, first storage-location information indicating a storage location where electronic source data of the printed material is stored. The acquirer acquires the electronic source data from the storage location indicated by the first storage-location information. The operation acceptance unit displays pieces of to-be-acquired information that are a unit of information acquired from the electronic source data, and accepts an operation input specifying selection of at least one piece of to-be-acquired information. The storage control unit stores the selected piece of to-be-acquired information in a storage location indicated by second storage-location information.

### CROSS-REFERENCE TO RELATED APPLICATIONS

The present application claims priority under 35 U.S.C. §119 to Japanese Patent Application No. 2016-039162, filed on Mar. 1, 2016. The contents of which are incorporated herein by reference in their entirety.

### BACKGROUND OF THE INVENTION

1. Field of the Invention

The present invention relates to an image processing apparatus, an image processing method, and a computer program product.

2. Description of the Related Art

Organizers of a conference, meeting, and the like often hand out a printed material. Attendees that receive the printed material may desire to obtain electronic data of the printed material.

Techniques of adding a digital watermark to a printed material by image processing are conventionally known. Digital watermarking is used to protect information security, for example. For example, Japanese Patent No. 4406589 (Patent Document 1) discloses a network printing system configured to be capable of determining whether or not eavesdropping of print data by an eavesdropper has occurred between a user device and a printing apparatus.

Conventionally, to obtain the electronic data, the attendees take a trouble of asking a location of (e.g., a file path or a link to) the electronic data or requesting to transmit the electronic data.

### SUMMARY OF THE INVENTION

According to one aspect of the present invention, an image processing apparatus includes a reading control unit, an extractor, an acquirer, an operation acceptance unit, and a storage control unit. The reading control unit reads a printed material containing a digital watermark to obtain image data of the printed material. The extractor extracts, from the digital watermark contained in the image data, first storage-location information indicating a storage location where electronic source data of the printed material is stored. The acquirer acquires the electronic source data from the storage location indicated by the first storage-location information. The operation acceptance unit displays pieces of to-be-acquired information that are a unit of information acquired from the electronic data, and accepts an operation input specifying selection of at least one piece of to-be-acquired information. The storage control unit stores the selected piece of to-be-acquired information in a storage location indicated by second storage-location information.

### BRIEF DESCRIPTION OF THE DRAWINGS

FIG. 1 is a diagram illustrating an example of a configuration of an image processing system of an embodiment;

FIG. 2 is a diagram illustrating an example of a software architecture of an image processing apparatus of the embodiment;

FIG. 3 is a diagram illustrating an example of a hardware architecture of the image processing apparatus of the embodiment;

FIG. 4 is a diagram illustrating an example of a functional architecture of the image processing apparatus of the embodiment;

FIG. 5 is a diagram illustrating a printed material containing a digital watermark;

FIG. 6 is a diagram illustrating an example of a functional architecture of an information processing apparatus of the embodiment;

FIG. 7 is a diagram illustrating an example of a hardware architecture of the information processing apparatus of the embodiment;

FIG. 8 is a sequence diagram illustrating an example of an image processing method of the embodiment;

FIG. 9 is a flowchart illustrating an example of a storage control method of the embodiment; and

FIG. 10 is a diagram illustrating an example of an access-right error screen of the present embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An object of an embodiment is to provide an image processing apparatus, an image processing method, and a computer program product that are capable of delivering electronic source data of a printed material to a user more conveniently.

Embodiments are described in detail below with reference to the accompanying drawings.

Configuration of Image Processing System

A configuration of an image processing system of an embodiment is described first.

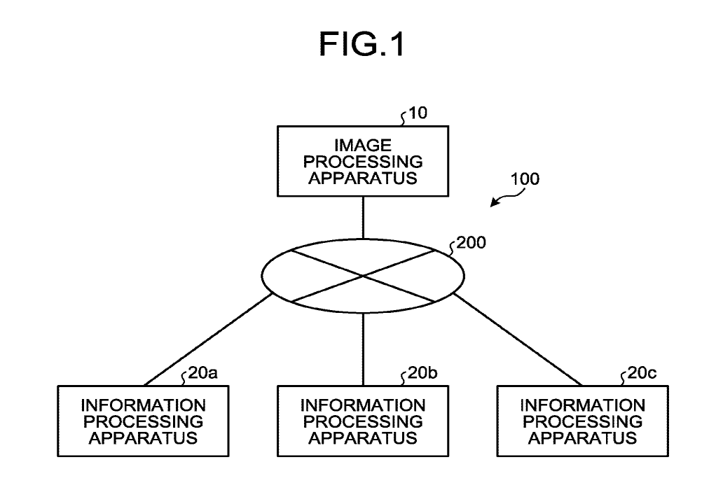

FIG. 1 is a diagram illustrating an example of the configuration of an image processing system 100 of the embodiment. The image processing system 100 of the embodiment includes an image processing apparatus 10, an information processing apparatus 20a, an information processing apparatus 20b, and an information processing apparatus 20c. Hereinafter, the term “information processing apparatus 20” is used to denote one of the information processing apparatus 20a, the information processing apparatus 20b, and the information processing apparatus 20c when differentiation therebetween is unnecessary.

The image processing apparatus 10 and the information processing apparatuses 20 are connected to each other via a network 200. Communication via the network 200 may be either wired communication or wireless communication. The network 200 may be implemented as a mixture of wired communication and wireless communication.

The image processing apparatus 10 of the embodiment is, for example, an MFP (Multifunction Peripheral). The information processing apparatus 20 of the embodiment is, for example, a personal computer, a smart device, or the like.

Software Architecture of Image Processing Apparatus

An example of a software architecture of the image processing apparatus 10 of the embodiment is described below.

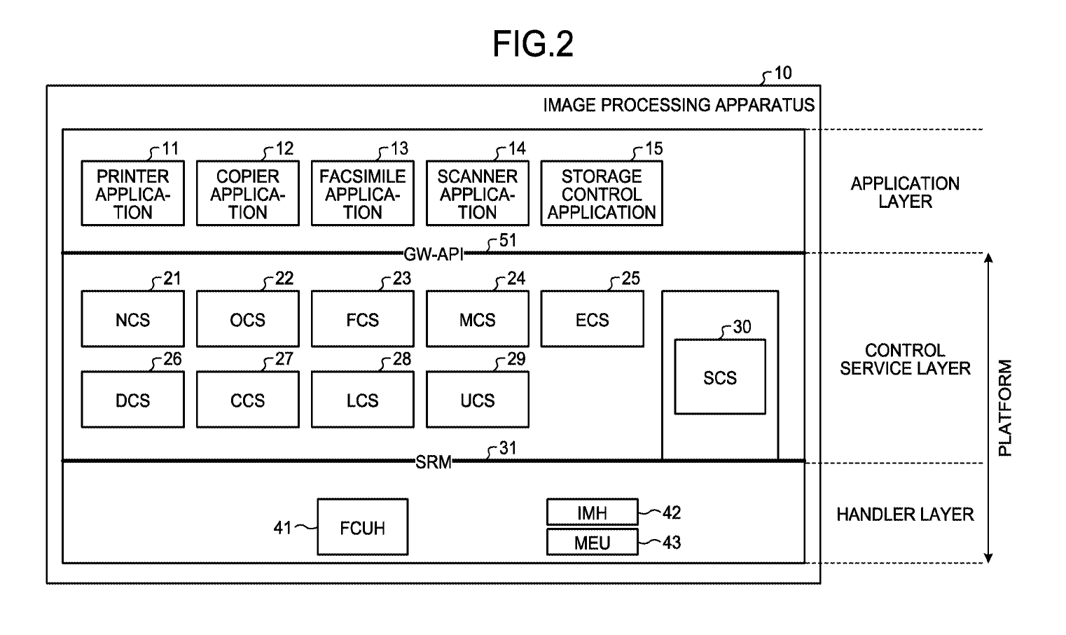

FIG. 2 is a diagram illustrating an example of the software architecture of the image processing apparatus 10 of the embodiment. The image processing apparatus 10 of the embodiment includes software in an application layer and software in a platform. The software in the platform includes software in a control service layer and software in a handler layer. Some or all of software pieces of the image processing apparatus 10 of the embodiment may be implemented in hardware.

The software in the platform receives a processing request from the software in the application layer using a GW-API (Application Programming Interface) 51. The GW-API 51 is a set of functions predefined to perform processing that allows the software in the application layer to use the software in the control service layer.

The software in the application layer and the software in the platform operate on an operating system (OS), e.g., UNIX (registered trademark). The OS executes the software in the application layer and the software in the platform in parallel as processes.

The software in the application layer performs processing for implementing a service(s) provided by the image processing apparatus 10 to a user.

The application layer includes a printer application 11, a copier application 12, a facsimile application 13, a scanner application 14, and a storage control application 15. The printer application 11 performs processing that controls a printing function. The copier application 12 performs processing that controls a copying function. The facsimile application 13 performs processing that controls a facsimile function. The scanner application 14 performs processing that controls a scanner function.

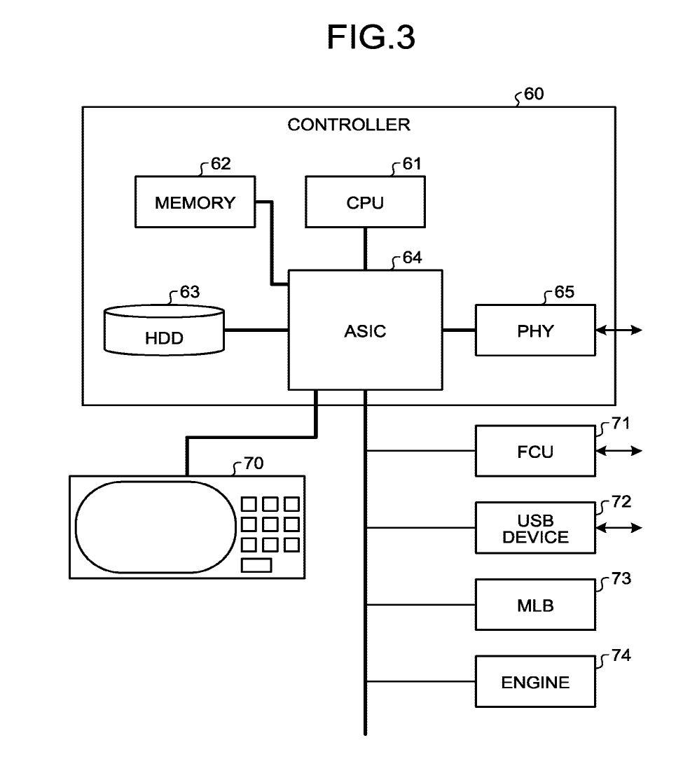

The storage control application 15 performs storage control processing, such as reading, adding, altering, and deleting information. Information to be stored in the image processing apparatus 10 is stored in a memory 62 and an HDD (Hard Disk Drive) 63 (see FIG. 3), which will be described later. The storage control application 15 assigns access right levels to the information stored in the image processing apparatus 10. The access right levels are sharing settings that enable access from a plurality of users, for example. A whole or a part of processing performed by the storage control application 15 may alternatively be performed by the OS.

The software in the control service layer receives a processing request from the software in the application layer and transmits a request for a hardware resource(s) based on the processing request to an SRM (System Resource Manager) 31. The SRM 31 will be described later.

The control service layer includes an NCS (Network Control Service) 21, an OCS (Operation panel Control Service) 22, an FCS (Fax Control Service) 23, an MCS (Memory Control Service) 24, an ECS (Engine Control Service) 25, a DCS (Delivery Control Service) 26, a CCS (Certification and Charge Control Service) 27, an LCS (Log Control Service) 28, a UCS (User Control Service) 29, and an SCS (System Control Service) 30.

The NCS 21 performs communication control processing for software that involves network I/O (input/output) operations. Specifically, the NCS 21 receives data from the information processing apparatuses 20 via the network 200 using various protocols and allocates the data to corresponding pieces of software running on the image processing apparatus 10. The NCS 21 also receives data from different pieces of software running on the image processing apparatus 10 and transmits the data to the information processing apparatuses 20 connected to the network 200 using various protocols.

The OCS 22 performs control processing for an operation panel that accepts an operation input entered by a user.

The FCS 23 performs, in response to a request from the facsimile application 13, facsimile transmission/reception processing that uses a PSTN (Public Switched Telephone Network) or an ISDN (Integrated Services Digital Network). The FCS 23 also performs, in response to a request from the facsimile application 13, a process of storing facsimile data in a backup memory, a process of retrieving facsimile data from the backup memory, a process of reading facsimile data, a process of performing printing upon receiving a facsimile, and the like.

The MCS 24 performs storage control processing including allocation and deallocation of memory used by pieces of software and writing and reading data to and from an HDD.

The ECS 25 performs control processing for an engine 74 (see FIG. 3), which is hardware that performs scanning and printing.

The DCS 26 performs control processing for, for example, delivery of information stored in the image processing apparatus 10.

The CCS 27 performs a user authentication process and control processing related to charging a fee(s) for a service(s) provided by the image processing apparatus 10.

Any authentication process may be used as the authentication process that authenticates a user. Examples of the user authentication process include reading an ID card by which a user is identified and performing verification against a set of user identification information and a password.

The reading an ID card is, more specifically, reading user identification information contained in the ID card from the ID card using a reading device that uses NFC (Near Field Communication), for example.

The performing verification against a set of user identification information and a password is, more specifically, accepting entry of the user identification information and the password and verifying the user identification information and the password against a set of user identification information and a password stored in the image processing apparatus 10. When an attempt of using the image processing apparatus 10 is made via the network 200 from the information processing apparatus 20, for example, the image processing apparatus 10 receives identification information and a password of a user from the information processing apparatus 20, thereby authenticating the user of the information processing apparatus 20.

The LCS 28 performs storage control processing for logs output from pieces of software running on the image processing apparatus 10.

The UCS 29 performs storage control processing including reading, adding, altering, and deleting user information. Examples of the user information include user identification information and a password used in the user authentication.

The SCS 30 performs control processing including software management, controlling an operating unit, such as the operation panel, displaying a system screen, indication with an LED(s) (light-emitting diode(s)), hardware resource management, and controlling application's interruption.

The SRM 31 performs, together with the SCS 30, system control processing and hardware-resource control processing of the image processing apparatus 10. The SRM 31 receives a hardware resource acquisition request from software that uses hardware, such as a plotter included in the engine 74 (see FIG. 3), in the upper layer, arbitrates hardware resource acquisition requests received from the pieces of software, and controls allocation of one or more hardware resources.

Specifically, the SRM 31 determines whether or not a hardware resource specified in the hardware resource acquisition request is available (put another way, whether or not the hardware resource is already used by another piece of software in response to a hardware resource acquisition request received from the other piece of software). When the hardware resource specified in the hardware resource acquisition request is available, the SRM 31 sends a notification that the hardware resource is available to the software in the upper layer that has transmitted the hardware resource acquisition request.

Furthermore, the SRM 31 performs scheduling of hardware resource acquisition requests received from the upper layer to thereby give instructions to perform operations (e.g., paper conveyance, image formation, memory allocation, and file generation) specified by the hardware resource acquisition requests. An engine I/F is used when the SRM 31 directly instructs the engine 74 (see FIG. 3) to perform an operation. The engine I/F is a set of functions predefined to issue a processing request(s) to the engine 74.

The software in the handler layer receives a hardware resource acquisition request from the SRM 31 and acquires a hardware resource(s) according to the hardware resource acquisition request.

The handler layer includes an FCUH (Fax Control Unit Handler) 41, an IMH (Image Memory Handler) 42, and an MEU (Media Edit Utility) 43.

The FCUH 41 receives, from the SRM 31, a hardware resource acquisition request with respect to a facsimile control unit included in the engine 74 (see FIG. 3) and controls operations of the facsimile control unit. The above-described engine I/F is used also when the FCUH 41 transmits a processing request to the facsimile control unit.

The IMH 42 receives, from the SRM 31, hardware resource acquisition requests with respect to a memory and controls allocation of the memory used by software pieces in the upper layer.

The MEU 43 receives, from the SRM 31, a hardware resource acquisition request and controls operations of hardware that performs image processing, such as image conversion control.

As an example operation of the software described above, a case where the image processing apparatus 10 performs a copying process is specifically described below.

First, the OCS 22, the CCS 27, and the UCS 29 perform the user authentication process. Specifically, upon accepting an operation input specifying identification information and a password of a user, the OCS 22 transmits the user identification information and the password to the CCS 27. Upon receiving the user identification information and the password from the OCS 22, the CCS 27 performs user authentication by verifying whether or not the set of the identification information and the password is stored in the image processing apparatus 10 via the UCS 29.

Next, the OCS 22 accepts an operation input, which is entered by, for example, pressing “COPY” button, specifying that the copier application 12 be operated.

Next, the copier application 12 requests the MCS 24 to allocate a memory for use in the copying process and requests the ECS 25 to control reading performed by the engine 74 (see FIG. 3). In response thereto, processing is performed by software (the SCS 30 and the SRM 31) in a still lower service layer. The SRM 31 transmits and receives information to and from the engine 74 via the engine I/F. Data output from the engine 74 is held by the memory that is under storage control of the IMH 42. When an image is fed from the ECS 25 to the engine 74, the engine 74 prints the image. The LCS 28 stores a log of a series of processes, from the user authentication process to the printing process, performed by the above-described software pieces in the image processing apparatus 10.

Hardware Architecture of Image Processing Apparatus

An example of a hardware architecture of the image processing apparatus 10 of the embodiment is described below.

FIG. 3 is a diagram illustrating an example of the hardware architecture of the image processing apparatus 10 of the embodiment. The image processing apparatus 10 of the embodiment includes a controller 60, an operation panel 70, an FCU (Facsimile Control Unit) 71, a USB (Universal Serial Bus) device 72, an MLB (Media Link Board) 73, and the engine 74.

The controller 60 is a control device that controls operations of the image processing apparatus 10. The controller 60 includes a CPU (Central Processing Unit) 61, the memory 62, the HDD 63, an ASIC (Application Specific Integrated Circuit) 64, and a PHY (Physical Layer Chip) 65.

The CPU 61 executes the software in the application layer, the control service layer, and the handler layer described above that controls operations of the image processing apparatus 10.

The memory 62 is a main storage device of the image processing apparatus 10. The HDD 63 is an auxiliary storage device of the image processing apparatus 10. The HDD 63 stores, for example, the software in the application layer, the control service layer, and the handler layer described above. The software in the application layer, the control service layer, and the handler layer described above is read out by the CPU 61 from the HDD 63 to be loaded into the memory 62.

The ASIC 64 is an integrated circuit that controls operations of the image processing apparatus 10. The CPU 61, the memory 62, the HDD 63, the PHY 65, the operation panel 70, the FCU 71, the USB device 72, the MLB 73, and the engine 74 are connected to the ASIC 64 via data transfer buses.

The PHY 65 controls communication with the information processing apparatuses 20 connected to the network 200.

The operation panel 70 is a user interface that accepts instructions to perform various jobs and inputs for configuring settings from a user of the image processing apparatus 10 and displays various types of information to be presented to the user.

The FCU 71 is a control unit that controls the facsimile function of the image processing apparatus 10.

The USB device 72 is an interface for connecting a USB device(s).

The MLB 73 is a conversion board that performs image-data format conversion.

The engine 74 includes a scanner engine that performs image reading and a plotter engine that performs printing.

Functional Architecture of Image Processing Apparatus

An example of a functional architecture of the image processing apparatus 10 implemented through cooperation of the hardware and the software described above is described below.

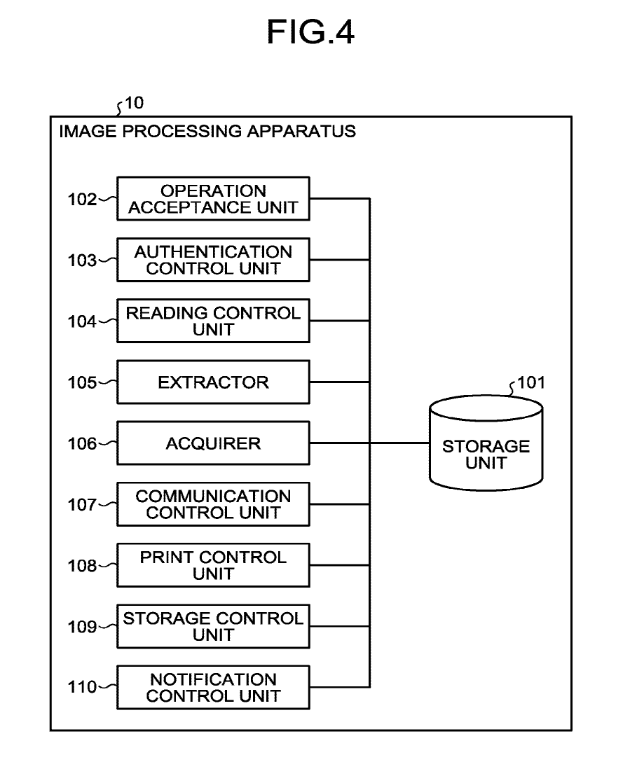

FIG. 4 is a diagram illustrating an example of the functional architecture of the image processing apparatus 10 of the embodiment. The image processing apparatus 10 of the embodiment includes a storage unit 101, an operation acceptance unit 102, an authentication control unit 103, a reading control unit 104, an extractor 105, an acquirer 106, a communication control unit 107, a print control unit 108, a storage control unit 109, and a notification control unit 110.

The storage unit 101 stores information. Examples of the information stored in the storage unit 101 include user information. The user information contains identification information by which a user is identified, an access right level of the user, and an electronic mail (hereinafter, “e-mail”) address of the user. The user's access right level is used by the storage control unit 109 during storage control of pieces of to-be-acquired information, which are a unit of information acquired from electronic data. The user's e-mail address is referred to by the notification control unit 110.

Access right levels may be assigned to users as follows when, for example, the image processing apparatus 10 is used in a business company or the like: level 0 is assigned to guest users; level 1 is assigned to general staffs; level 2 is assigned to management staffs; and level 3 is assigned to system administrators. The higher the number, the higher the access right. The access right levels may be assigned to users as desired.

Another example of the information stored in the storage unit 101 is a log indicating operations performed by functions of the image processing apparatus 10 in accordance with an instruction given from a user authenticated by the authentication control unit 103.

Still another example of the information stored in the storage unit 101 is image data of a printed material read by the reading control unit 104. The image data read by the reading control unit 104 may be of any data format. Examples of the data format of the image data read by the reading control unit 104 include JPEG format, TIFF format, and PDF format.

The operation acceptance unit 102 displays a UI (User Interface) screen(s) and accepts an operation input from a user. Examples of the UI screen include a selection screen for accepting information selection from a user and a setting screen for accepting settings of information from a user.

The authentication control unit 103 authenticates a user through the above-described authentication process (login process) and acquires an access right level associated with identification information of the user from the storage unit 101.

The reading control unit 104 reads a printed material containing a digital watermark to obtain image data of the printed material.

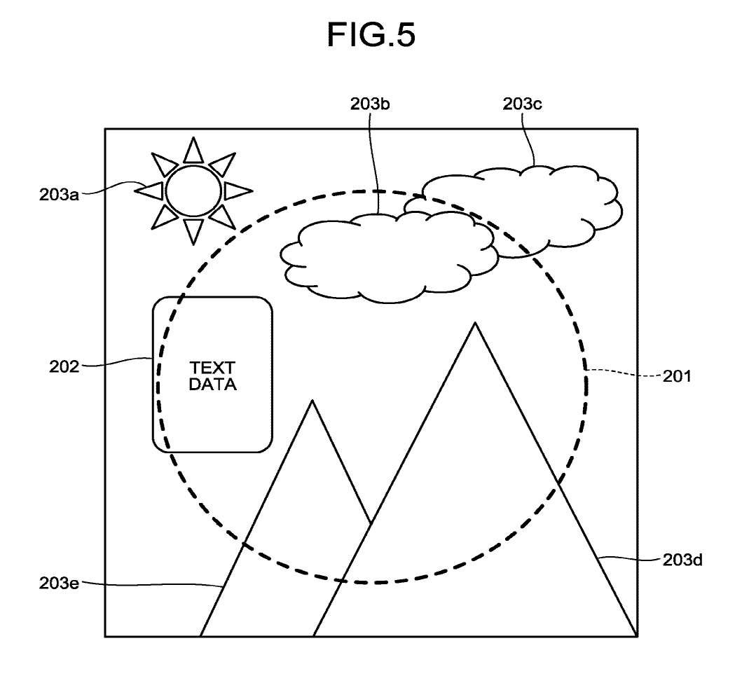

FIG. 5 is a diagram illustrating an example of a printed material containing a digital watermark 201. The example printed material of FIG. 5 contains the digital watermark 201 indicated by a dashed line circle, text 202, an image of the Sun (hereinafter, “Sun image”) 203a, an image of a cloud (hereinafter, “cloud image”) 203b, a cloud image 203c, an image of a mountain (hereinafter, “mountain image”) 203d, and a mountain image 203e.

The digital watermark 201 contains information about electronic source data of the printed material. The information about the electronic source data is, for example, information (hereinafter, “first storage-location information”) indicating a storage location where the electronic source data of the printed material is stored. Examples of the first storage-location information include information by which the information processing apparatus 20 that stores the electronic source data of the printed material is identified, a file path to the information processing apparatus 20 indicating the storage location of the electronic source data, and a file name of the electronic source data. Examples of the information by which the information processing apparatus 20 is identified include the IP address and a host name of the information processing apparatus 20. The first storage-location information will be referred to by the acquirer 106 when acquiring the electronic source data of the printed material.

Another example of the information about the electronic source data is an access right level set for each unit of information (hereinafter, “to-be-acquired information”) to be acquired from the electronic source data.

In the example of FIG. 5, pieces of to-be-acquired information are, for example, the electronic data, the text 202 contained in the electronic data, and the images 203 (the Sun image 203a, the cloud image 203b, the cloud image 203c, the mountain image 203d, and the mountain image 203e), which may be in JPEG format or the like, contained in the electronic source data. The access right levels are assigned to the pieces of to-be-acquired information as follows, for example. Level 3 is assigned to the electronic source data; level 2 is assigned to the text 202; level 1 is assigned to the images 203, which may be in JPEG format or the like, contained in the electronic source data. The access right levels of the pieces of to-be-acquired information may be determined as desired. A user can acquire the to-be-acquired information when the user has an access right level equal to or higher than the access right level set to the to-be-acquired information.

The access right levels may be contained in the electronic source data in a data format other than that of the digital watermark 201. In this case, the acquirer 106 preferably acquires the access right levels of the pieces of to-be-acquired information from the electronic source data when the acquirer 106 acquires the electronic source data containing the pieces of to-be-acquired information.

Referring back to FIG. 4, the extractor 105 extracts the above-described first storage-location information from the digital watermark 201 contained in the image data read by the reading control unit 104.

The acquirer 106 acquires the electronic source data of the printed material read by the reading control unit 104 from the storage location indicated by the first storage-location information via the communication control unit 107. The acquirer 106 displays, on the operation acceptance unit 102, a selection screen for selecting at least one piece of the to-be-acquired information contained in the acquired electronic data.

The communication control unit 107 performs a communication process of communicating with the information processing apparatuses 20 connected to the network 200. The communication control unit 107 feeds data received via the network 200 to a functional unit(s) other than the communication control unit 107. Upon receiving, from a functional unit(s) other than the communication control unit 107, data to be transmitted, the communication control unit 107 transmits the data to the corresponding information processing apparatus 20 via the network 200.

The print control unit 108 makes a copy of the printed material in accordance with a copying operation accepted by the operation acceptance unit 102 and performs printing of electronic data in accordance with a print job received from the information processing apparatus 20 via the communication control unit 107.

The storage control unit 109 stores information in the storage unit 101 and the like.

When, for example, the user has an access right level equal to or higher than the access right level assigned to the selected to-be-acquired information, the storage control unit 109 stores the selected to-be-acquired information selected through the operation acceptance unit 102 in a storage location indicated by second storage-location information. Hence, the electronic source data of the printed material can be delivered to the user more conveniently.

The storage location indicated by the second storage-location information may be any location. An example of the storage location indicated by the second storage-location information is a file path to the image processing apparatus 10 provided in advance for a user that is currently logged in and that has entered an operation input that instructs to read the printed material through the operation acceptance unit 102. Another example of the storage location indicated by the second storage-location information is a predetermined file path to the information processing apparatus 20. The file path may be a file path to an external storage medium, such as an SD card.

The storage control unit 109 may store, for example, a log indicating a result of the above-described authentication process performed by the authentication control unit 103 in the storage unit 101. The log indicating the authentication result may contain, for example, date and time when the authentication process is performed, the identification information by which the user is identified, and the authentication result (successfully authenticated or not authenticated).

When the to-be-acquired information selected by the user is stored in the storage location indicated by the second storage-location information, the storage control unit 109 may store, for example, a log in the storage unit 101. The log may contain identification information of the user that has selected the to-be-acquired information through the operation acceptance unit 102, specifying information for identifying the selected to-be-acquired information, and the second storage-location information. Hence, the user that has acquired the to-be-acquired information contained in the electronic data can be identified from the log stored in the storage unit 101.

The specifying information for identifying the selected to-be-acquired information may be any information. Examples of the specifying information for identifying the selected to-be-acquired information include a data name of the to-be-acquired information and a hash value calculated from the to-be-acquired information.

The notification control unit 110 sends the second storage-location information to a contact address of the user via the communication control unit 107. The method of sending the information to the contact address of the user may be any method. Examples of the contact address of the user include an e-mail address of the user.

Functional Architecture of Information Processing Apparatus

An example of a functional architecture of the information processing apparatus 20 of the embodiment is described below.

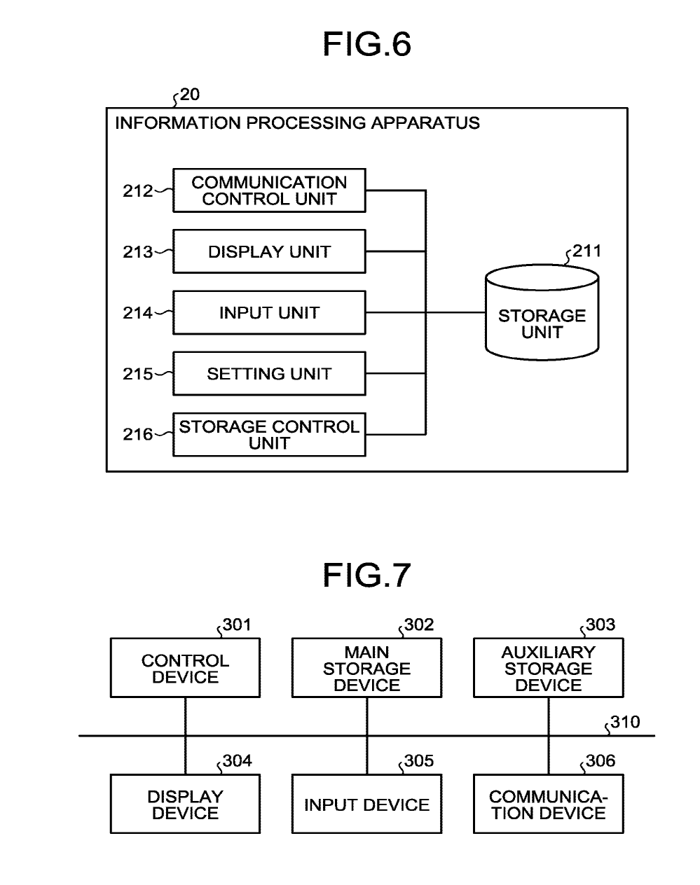

FIG. 6 is a diagram illustrating an example of the functional architecture of the information processing apparatus 20 of the embodiment. The information processing apparatus 20 of the embodiment includes a storage unit 211, a communication control unit 212, a display unit 213, an input unit 214, a setting unit 215, and a storage control unit 216.

The storage unit 211 stores information. Examples of the information stored in the storage unit 211 include electronic data generated by word processor software, spreadsheet software, presentation software, or the like of the information processing apparatus 20.

The communication control unit 212 communicates with the image processing apparatus 10 and the information processing apparatuses 20 other than the information processing apparatus 20, to which the communication control unit 212 belongs, via the network 200. The communication control unit 212 transmits a print job to the image processing apparatus 10, for example.

The display unit 213 displays information. The display unit 213 displays a setting screen for assigning access right levels to the pieces of to-be-acquired information contained in the electronic data, for example.

The input unit 214 accepts an input to operate the information processing apparatus 20. For example, the input unit 214 accepts an operation input to assign access right levels to the respective pieces of to-be-acquired information contained in the electronic data from the above-described setting screen. Furthermore, the input unit 214 accepts an input of the first storage-location information indicating the storage location where the electronic data is stored, for example.

The setting unit 215 sets, to the electronic source data, information indicating the access authority levels of the pieces of to-be-acquired information contained in the electronic source data in response to the user's operation input accepted by the input unit 214. The method of setting the information indicating the access right levels to the electronic source data may be any method. For example, the setting unit 215 may cause the information indicating the access right levels to be contained in the digital watermark 201.

The setting unit 215 also adds the digital watermark 201 containing the first storage-location information to the electronic data.

The storage control unit 216 stores information in the storage unit 211 of the information processing apparatus 20, to which the storage control unit 216 belongs, or the storage unit 211 or the like of the other information processing apparatus 20. For example, the setting control unit 216 stores the electronic source data containing the digital watermark 201 in the storage location indicated by the first storage-location information.

Hardware Architecture of Information Processing Apparatus

An example of a hardware architecture of the information processing apparatus 20 of the embodiment is described below.

FIG. 7 is a diagram illustrating an example of the hardware architecture of the information processing apparatus 20 of the embodiment. The information processing apparatus 20 of the embodiment includes a control device 301, a main storage device 302, an auxiliary storage device 303, a display device 304, an input device 305, and a communication device 306. The control device 301, the main storage device 302, the auxiliary storage device 303, the display device 304, the input device 305, and the communication device 306 are connected to each other via a bus 310.

The control device 301 executes program instructions (hereinafter, “program”) read out from the auxiliary storage device 303 and loaded into the main storage device 302. The main storage device 302 is a memory, such as a ROM and a RAM. The auxiliary storage device 303 is a memory card or the like.

The display device 304 displays information. The display device 304 is a liquid crystal display, for example. The input device 305 accepts an input of information. The input device 305 is a keyboard and a mouse, for example. The display device 304 and the input device 305 may be a liquid-crystal touch panel having a display function and an input function, for example. The communication device 306 communicates with other apparatuses.

The program to be executed by the information processing apparatus 20 may be provided as a computer program product recorded in a non-transitory computer-readable recording medium, such as a CD-ROM, a memory card, a CD-R, and a DVD (Digital Versatile Disk), as an installable file or an executable file.

The program to be executed by the information processing apparatus 20 may be configured to be stored in a computer connected to a network, such as the Internet, and provided by being downloaded via the network. The program to be executed by the information processing apparatus 20 may be configured to be provided via a network, such as the Internet, by a method other than downloading.

The program of the information processing apparatus 20 may be configured to be provided in a form loaded into a ROM or the like in advance.

The program to be executed by the information processing apparatus 20 is configured in modules including program-implementable functional units of the above-described functional units. From an actual hardware perspective, the program-implementable functional blocks are loaded into the main storage device 302 by the control device 301 by reading out the program from a recording medium, such as the auxiliary storage device 303, and executing the program. Thus, the program-implementable functional blocks are created on the main storage device 302.

Some or all of the program-implementable functional blocks may be implemented in hardware, such as an IC (Integrated Circuit), rather than by the program.

Image Processing Method

An image processing method of the embodiment is described below.

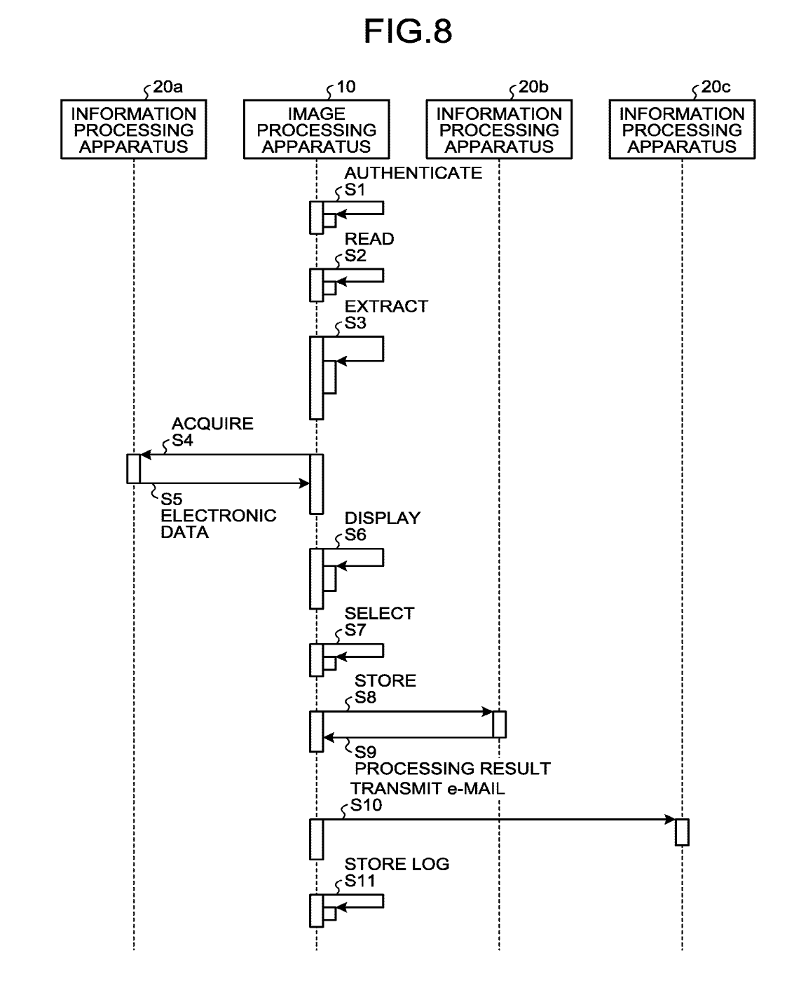

FIG. 8 is a sequence diagram illustrating an example of the image processing method of the embodiment. First, the authentication control unit 103 of the image processing apparatus 10 authenticates a user through the above-described authentication process (login process) and acquires an access right level associated with identification information of the user from the storage unit 101 (step S1).

Next, the reading control unit 104 of the image processing apparatus 10 reads a printed material containing the digital watermark 201 to obtain image data of the printed material (step S2).

Next, the extractor 105 of the image processing apparatus 10 extracts the above-described first storage-location information from the digital watermark 201 contained in the image data read at step S2 (step S3).

Next, the acquirer 106 of the image processing apparatus 10 acquires electronic source data of the printed material read at step S2 from a storage location indicated by the first storage-location information extracted at step S3 via the communication control unit 107 (steps S4 and S5). FIG. 8 illustrates an example where the first storage-location information contains a file path to the storage unit 211 of the information processing apparatus 20a.

Next, the acquirer 106 of the image processing apparatus 10 displays a selection screen for selecting to-be-acquired information contained in the electronic data acquired at step S5 on the operation acceptance unit 102 (step S6).

Next, the operation acceptance unit 102 of the image processing apparatus 10 accepts an operation input specifying selection of at least one piece of the to-be-acquired information via the selection screen displayed at step S6 (step S7).

Next, when the user authenticated at step S1 has an access right level equal to or higher than an access right level assigned to the selected to-be-acquired information, the storage control unit 109 of the image processing apparatus 10 stores the to-be-acquired information selected at step S7 in a storage location indicated by the above-described second storage-location information (step S8). FIG. 8 illustrates an example where the second storage-location information contains a file path to the storage unit 211 of the information processing apparatus 20b.

Next, the communication control unit 212 of the information processing apparatus 20b transmits a result (“success” or “failure”) of processing performed at step S8 to the image processing apparatus 10 (step S9).

Next, when the processing result transmitted at step S9 is “success”, (the notification control unit 110 of) the image processing apparatus 10 sends the second storage-location information to a contact address of the user via the communication control unit 107 (step S10). FIG. 8 illustrates an example where the contact address of the user is the e-mail address used on the information processing apparatus 20c.

Next, the storage control unit 109 of the image processing apparatus 10 stores, in the storage unit 101, a log containing identification information of the user that has entered the operation input to select the to-be-acquired information at step S7, specifying information for identifying the to-be-acquired information selected at step S7, and the above-described second storage-location information (step S11).

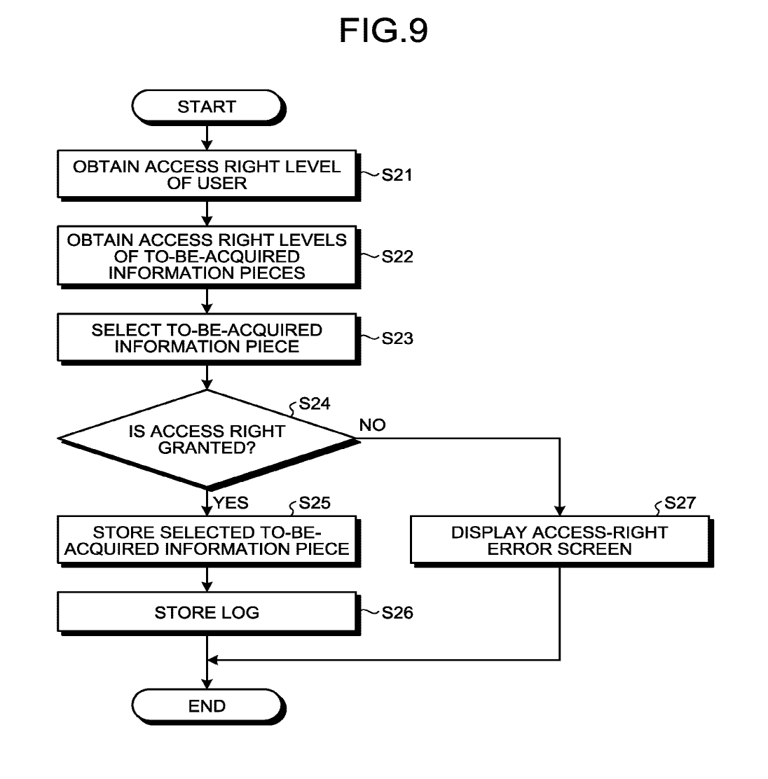

FIG. 9 is a flowchart illustrating an example of a storage control method of the embodiment. First, the storage control unit 109 obtains an access right level of a user acquired by the authentication control unit 103 during authentication of the user (step S21). Next, the storage control unit 109 obtains access right levels of respective pieces of to-be-acquired information contained in electronic source data acquired by the acquirer 106 from a storage location indicated by the first storage-location information (step S22).

Next, the operation acceptance unit 102 accepts an operation input specifying selection of at least one piece of to-be-acquired information contained in the electronic source data (step S23).

Next, the storage control unit 109 determines whether or not the user's access right level obtained at step S21 is equal to or higher than the access right level of the to-be-acquired information selected at step S23 (step S24).

When the user's access right level is equal to or higher than the access right level of the to-be-acquired information selected at step S23 (Yes at step S24), the storage control unit 109 stores the to-be-acquired information selected at step S23 in a storage location indicated by the second storage-location information (step S25). Next, the storage control unit 109 stores, in the storage unit 101, a log containing identification information of the user that has entered the operation input that selects the to-be-acquired information at step S23, specifying information for identifying the to-be-acquired information selected at step S23, and the second storage-location information (step S26).

When the user's access right level is lower than the access right level of the to-be-acquired information selected at step S23 (No at step S24), the operation acceptance unit 102 displays an access-right error screen (step S27).

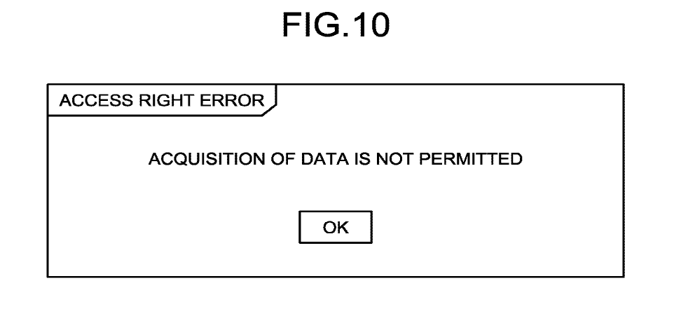

FIG. 10 is a diagram illustrating an example of the access-right error screen of the present embodiment. FIG. 10 illustrates an example where notification that acquisition of data is not permitted is presented using a dialog box.

As described above, in the image processing apparatus 10 of the embodiment, the extractor 105 extracts, from the digital watermark 201 contained in image data, first storage-location information indicating a storage location where electronic source data of a printed material is stored. The acquirer 106 acquires the electronic source data from the storage location indicated by the first storage-location information. The operation acceptance unit 102 displays pieces of to-be-acquired information, which are a unit of information acquired from the electronic source data, and accepts an operation input specifying selection of at least one piece of to-be-acquired information. The storage control unit 109 stores the selected piece of to-be-acquired information in a storage location indicated by second storage-location information.

Hence, the image processing apparatus 10 of the embodiment can deliver the electronic source data of the printed material to a user more easily.

In the above-description, the storage control unit 109 stores the selected to-be-acquired information in the storage location indicated by the second storage-location information; the notification control unit 110 sends the second storage-location information to the user's contact address. Alternatively, the notification control unit 110 may transmit the selected to-be-acquired information directly to the user's e-mail address.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image processing apparatus comprising:
a reading control unit configured to read a printed material containing a digital watermark to obtain image data of the printed material;
an extractor configured to extract, from the digital watermark contained in the image data, first storage-location information indicating a storage location where electronic source data of the printed material is stored;
an acquirer configured to acquire the electronic source data from the storage location indicated by the first storage-location information;
an operation acceptance unit configured to display pieces of to-be-acquired information that are a unit of information acquired from the electronic source data, and accept an operation input specifying selection of at least one piece of to-be-acquired information; and
a storage control unit configured to store the selected piece of to-be-acquired information in a storage location indicated by second storage-location information.

2. The image processing apparatus according to claim 1, further comprising
an authentication control unit configured to authenticate a user and acquire an access right level associated with identification information of the user from a storage unit, wherein
when the access right level of the user is equal to or higher than an access right level assigned to the selected to-be-acquired information, the storage control unit stores the selected to-be-acquired information in the storage location indicated by the second storage-location information.

3. The image processing apparatus according to claim 2, further comprising a notification control unit configured to send the second storage-location information to a contact address of the user.

4. The image processing apparatus according to claim 1, wherein the to-be-acquired information contains at least one of the electronic source data, text contained in the electronic source data, and an image contained in the electronic source data.

5. The image processing apparatus according to claim 1, wherein each of the storage location indicated by the first storage-location information and the storage location indicated by the second storage-location information is any one of the image processing apparatus and an information processing apparatus connected to the image processing apparatus via a network.

6. The image processing apparatus according to claim 2, wherein when the selected to-be-acquired information is stored in the storage location indicated by the second storage-location information, the storage control unit stores a log in the storage unit, the log containing
identification information of a user that has selected the to-be-acquired information through the operation acceptance unit,
specifying information for identifying the selected to-be-acquired information, and
the second storage-location information.

7. An image processing method comprising:
reading, by an image processing apparatus, a printed material containing a digital watermark to obtain image data of the printed material;
extracting, by the image processing apparatus, from the digital watermark contained in the image data, first storage-location information indicating a storage location where electronic source data of the printed material is stored;
acquiring, by the image processing apparatus, the electronic source data from the storage location indicated by the first storage-location information;
displaying, by the image processing apparatus, pieces of to-be-acquired information that are a unit of information acquired from the electronic source data;
accepting an operation input specifying selection of at least one piece of to-be-acquired information; and
storing the selected piece of to-be-acquired information in a storage location indicated by second storage-location information.

8. A computer program product comprising a non-transitory computer-readable recording medium containing instructions that, when executed by a computer, cause the computer to function as:
a reading control unit configured to read a printed material containing a digital watermark to obtain image data of the printed material;
an extractor configured to extract, from the digital watermark contained in the image data, first storage-location information indicating a storage location where electronic source data of the printed material is stored;
an acquirer configured to acquire the electronic source data from the storage location indicated by the first storage-location information;
an operation acceptance unit configured to display pieces of to-be-acquired information that are a unit of information acquired from the electronic source data, and accept an operation input specifying selection of at least one piece of to-be-acquired information; and
a storage control unit configured to store the selected piece of to-be-acquired information in a storage location indicated by second storage-location information.
